(19) United States
(12) Patent Application Publication
(10) Pub. No.: US 2026/0192439 A1
(43) Pub. Date: Jul. 9, 2026

(54) MOBILE ROBOT HAVING A SPHERICAL WHEEL AND COMPRISING AN ARTICULATED TRUNK

(71) Applicant: ENCHANTED TOOLS, PARIS (FR)

(72) Inventor: Jerome MONCEAUX, PARIS (FR)

(73) Assignee: ENCHANTED TOOLS, PARIS (FR)

(21) Appl. No.: 19/130,236

(22) PCT Filed: Nov. 3, 2023
(86) PCT No.: PCT/EP2023/080698

§ 371 Date: May 15, 2025

(30) Foreign Application Priority Data
Nov. 23, 2022 (FR) FR2212236

(51) Int. Cl. B25J 5/00; B25J 15/00; B25J 17/00; B25J 19/02

(52) U.S. Cl. CPC B25J 5/007; B25J 15/0009; B25J 17/00; B25J 19/02

(57) ABSTRACT

The present invention relates to a robot (1) capable of moving on the ground by means of a spherical wheel (2) suitable for rolling on the ground, the robot (1) comprising a trunk (4), at least one arm (5) and an upper part (6), the trunk (4) being connected to the platform (3) and to the upper part (6), characterized in that the robot (1) can move by tilting between a straight position and a tilted position, the trunk (4) of the robot (1) comprising a first portion (40) and a second portion (41), the trunk (4) being configured to maintain the position of the center of mass (7) of the robot (1) so as to allow the robot (1) to tilt towards the ground.

### TECHNICAL FIELD

The present invention relates to the field of robots, especially of humanoid robots. More specifically, the invention relates to a robot with a single spherical wheel and a movable trunk, i.e. a trunk that can be tilted with respect to the spherical wheel.

### BACKGROUND

Robots having a single spherical wheel on which the entire robot rests are known. These types of robots are commonly referred to as “ballbots”. These robots are movable stably, in all directions, by means of the single spherical wheel.

In particular, robots with a single spherical wheel are known, each having a trunk, two arms and an upper part. The trunk is connected to the spherical wheel and is fixed with respect to same, each arm is connected to the trunk by means of a pin joint or by means of a ball-and-socket joint so as to allow mobility of each of the arms with respect to the trunk, and the upper part is connected to an upper portion of the trunk and is fixed with respect to same. The upper part of the robot includes at least one sensor configured to enable the robot to locate itself in its environment. Such a robot is configured to move in all directions and to perform tasks using its arms, such as gripping objects. In this case, the arms are fitted with clamps for gripping the objects to be grasped.

However, since only its arms are movable, such a robot can only perform tasks at arm height. In particular, it does not allow tasks to be carried out close to the ground. As a result, such a robot is intended to perform a specific type of task, at a specific height, and cannot adapt to its environment.

So-called humanoid robots, i.e. robots whose shape resembles the human body, with two legs, a trunk, two arms and a head, are also known. The legs have the same joints as human legs and are each connected to the trunk by means of a pin joint, the trunk is connected to each of the arms by means of a ball-and-socket joint or a pin joint, and the head is connected to the trunk by means of a pin joint. In this way, each part can be moved with respect to the others, and such robots offer a certain diversity of movement.

However, the legs have a plurality of mechanical parts and joints between each of them. The manufacture and use of the robot are therefore highly complex.

Robots similar to the previously disclosed humanoid robots are also known, but feature a baseplate to which at least three wheels are attached rather than a pair of legs. Thus, the robot is mobile in all directions by virtue of the wheels, the baseplate is connected to the trunk by means of a ball-and-socket joint, the trunk is connected to each of the arms by means of a ball-and-socket joint or a pin joint, and the head is connected to the trunk by means of a pin joint. In this way, each part can be moved with respect to the others, and such robots offer a certain diversity of movement.

However, the wheels coupled to the baseplate take up a lot of space, especially at ground level. Indeed, as each wheel is a bearing point for the robot on the ground, they need to be spaced apart from each other on the ground, so as to ensure the stability of the robot in both static and moving positions. In particular, wheel spacing is essential to prevent the robot from falling over when the trunk tilts with respect to the baseplate, for example. Thus, such a robot takes up a lot of space and may not be suitable for small environments.

The present invention therefore aims to solve the above-mentioned problems by proposing a robot that has a single spherical wheel for movement, in contact with the ground, on which the robot rests, a trunk, two arms and an upper part, in particular a robot with a movable trunk, i.e. a trunk that can be tilted with respect to the spherical wheel, enabling it to adapt to and interact with its environment. The robot according to the invention can perform a variety of tasks, at different heights, while taking up very little space and remaining stable.

### SUMMARY OF THE INVENTION

More precisely, the invention relates to a robot having a single spherical wheel for movement configured to be in contact with the ground and a platform mounted on the spherical wheel via stabilizing means, the robot being configured to be mobile on the ground by means of the spherical wheel suitable for rolling on the ground, the robot having a trunk, at least one arm and an upper part, the trunk being connected to the platform as well as to the upper part, the arm being connected by means of at least one pin joint or at least one ball-and-socket joint to the trunk. The robot is tiltably movable between a straight position and a tilted position, the trunk of the robot having a first portion and a second portion, the first portion being connected by a first end to the platform at least by means of a pin joint or a ball-and-socket joint, the second portion being connected by a first end to the upper part and the first portion being connected by a second end to a second end of the second portion at least by means of a pin joint or a ball-and-socket joint, the trunk being configured to maintain the position of the center of mass of the robot so as to allow the robot to tilt towards the ground.

The first and second portions allow the trunk, and therefore the robot, to tilt. The tilting of its trunk allows the robot to have an adjustable gripping height. In addition, the robot is stable on the spherical wheel in both static and moving positions, and in both straight and tilted positions. The robot can therefore tilt towards the ground to pick up and/or move the objects in its environment, while remaining stable and taking up little space. The robot operates at variable heights, making it adaptable to its environment. Also, the robot can adapt to the load of the object to be moved and/or gripped. Indeed, the weight of the object can offset the center of mass, causing the robot to become unstable. To maintain the balance of the robot while carrying the object, the first and/or second portion simply needs to be pivoted so as to re-center the center of mass.

In addition, the tilting of the trunk increases the field of vision of the robot and makes it closer to human movements, making it even more accessible.

According to a first embodiment, the first portion is connected by a first end to the platform by means of a pin joint, and the first portion is connected by a second end to a second end of the second portion by means of a pin joint.

According to a second embodiment, the first portion is connected by a first end to the platform by means of a ball-and-socket joint, and the first portion is connected by a second end to a second end of the second portion by means of a ball-and-socket joint.

Advantageously, in the straight position, the axis of the joint connecting the first end of the second portion to the upper part, the axis of the joint connecting the second end of the second portion to the second end of the first portion, and the axis of the joint connecting the first end of the first portion to the platform lie in a frontal plane of the robot, and, in the tilted position, at least the axis of the joint connecting the first end of the first portion to the platform lies in the frontal plane of the robot, the axis of the joint connecting the second end of the second portion to the second end of the first portion being at a distance from the frontal plane, and the axis of the joint connecting the first end of the second portion to the upper part lying in the frontal plane or at a distance from the frontal plane.

In this way, the trunk is tilted and the robot has an adjustable gripping height, and the position of the center of mass is maintained in the frontal plane A so as to keep the robot balanced. The robot is thus tiltable and stable, yet takes up very little space.

Advantageously still, the robot has two arms, said arms, in a tilted position, extending on either side of a frontal plane of said robot or on the same side of said frontal plane.

The presence of one arm enables the robot to grasp an object, and the presence of a plurality of arms enables it to grasp larger objects while maintaining stability.

Preferentially, in a tilted position, the robot has two arms extending on the same side of the frontal plane and, in said tilted position, the axis of the joint connecting the first end of the first portion to the platform lies in said frontal plane of the robot, and the axis of the joint connecting the second end of the second portion to the second end of the first portion and the axis of the joint connecting the first end of the second portion to the upper part are at a distance from said frontal plane.

More preferentially, in the tilted position the robot has two arms extending on either side of the frontal plane and, in said tilted position, the axis of the joint connecting the first end of the first portion to the platform and the axis of the joint connecting the first end of the second portion to the upper part lie in said frontal plane of the robot, and the axis of the joint connecting the second end of the second portion to the second end of the first portion is at a distance from said frontal plane.

Advantageously, the means for stabilizing the platform are configured to maintain the platform in a predetermined, especially horizontal, position with respect to the ground.

Even more advantageously, the at least one arm has a distal segment and a proximal segment, the distal segment and the proximal segment being connected by a pin-type joint or a ball-and-socket-type joint, the arm being configured to be movable between a stretched position in which the distal segment and the proximal segment are aligned and a bent position in which the proximal segment is tilted with respect to the distal segment.

Preferably, the robot also has at least one gripper, especially a hand, the gripper being connected by means of a pin joint or ball-and-socket joint to one end of the arm, the gripper having at least two fingers forming a clamp, the gripper being configured to grip objects.

### BRIEF DESCRIPTION OF THE DRAWINGS

The invention will be better understood upon reading the following description, given by way of example, and referring to the following figures, given as non-limiting examples, wherein identical references are given to similar objects, and wherein:

FIG. 1 is a schematic front view of the robot according to the invention, having a spherical wheel for movement and a platform mounted on the wheel, on which a trunk and an upper part are mounted, the trunk having first and second portions;

FIG. 2 is a view, from the right-hand side, of the robot of FIG. 1, with the robot in a straight position;

FIG. 3 is a view similar to FIG. 2, but with the robot having arms arranged along the trunk of the robot;

FIG. 4 is a view similar to FIG. 2, but with the robot in a tilted position;

FIG. 5 is a view similar to FIG. 3, but with the robot in a tilted position, with the arms substantially alongside the trunk;

FIG. 6 is a view similar to FIG. 5, but with the arms towards the front of the robot;

FIG. 7 is a view similar to FIG. 6, but in a more tilted position;

FIG. 8 is a view similar to FIG. 6, but with the arms towards the rear of the robot; and

FIG. 9 is a view similar to FIG. 5, but in a more tilted position.

It should be noted that the figures set forth the invention in detail to implement the invention; although non-limiting, said figures of course being capable of being used to further define the invention where appropriate.

### DETAILED DESCRIPTION OF THE INVENTION

The invention relates to a robot 1 having a single spherical wheel 2 configured to be in contact with the ground and a platform 3 mounted on the spherical wheel 2 via stabilizing means. The robot 1 rests on the spherical wheel 2 via the platform 2. This type of robot 1 is commonly referred to as a “ballbot”.

The robot 1 is movable stably on the ground in all directions by means of the single spherical wheel 2.

The platform 3 is mounted on the spherical wheel 2, so that a lower part of the spherical wheel 2 is permanently in contact with the ground. In particular, the platform 3 has stabilizing means configured to enable the robot 1 to be held stably on the spherical wheel 2 when the robot 1 is in a static position, but also when the robot 1 is in motion.

The stabilizing means may, for example, have retaining members 30 at least partially surrounding the spherical wheel 2. Herein, the stabilizing means have three retaining members 30 distributed around the spherical wheel 2.

The stabilizing means may also include at least one secondary wheel 31, in this case three secondary wheels 31, configured to rotate and to allow the spherical wheel 2 to move and/or the robot 1 to be held in a straight position depicted in the figures when it is static.

In the static position, the platform 3 of the robot extends substantially parallel to the ground and the robot lies in a frontal plane A, orthogonal to the ground.

In order to move, and thus to trigger the rotation of the at least one secondary wheel 31 and thus of the spherical wheel 2, the robot must tilt with respect to the frontal plane A in the desired direction. In this way, the robot 1 can move in any direction, omnidirectionally.

The robot 1 has a trunk 4, at least one arm 5 and an upper part 6.

In particular, the trunk 4 is connected to the platform 3 as well as to the upper part 6.

The arm 5 is connected to the trunk 4 by means of a pin-type joint or a ball-and-socket-type joint. The robot 1 may have a plurality of arms 5; in this case, the robot 1 has two arms 5, each connected by means of a pin-type joint or ball-and-socket-type joint to the trunk 4.

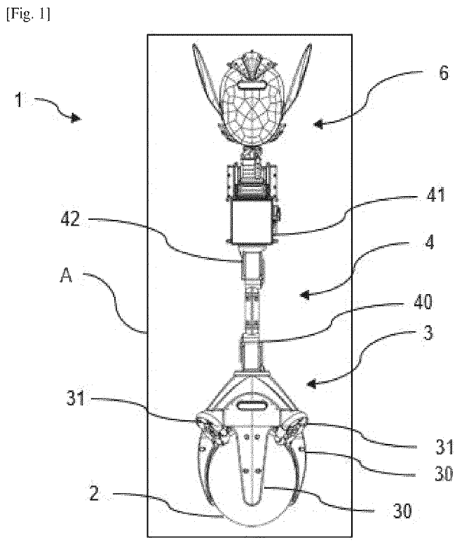

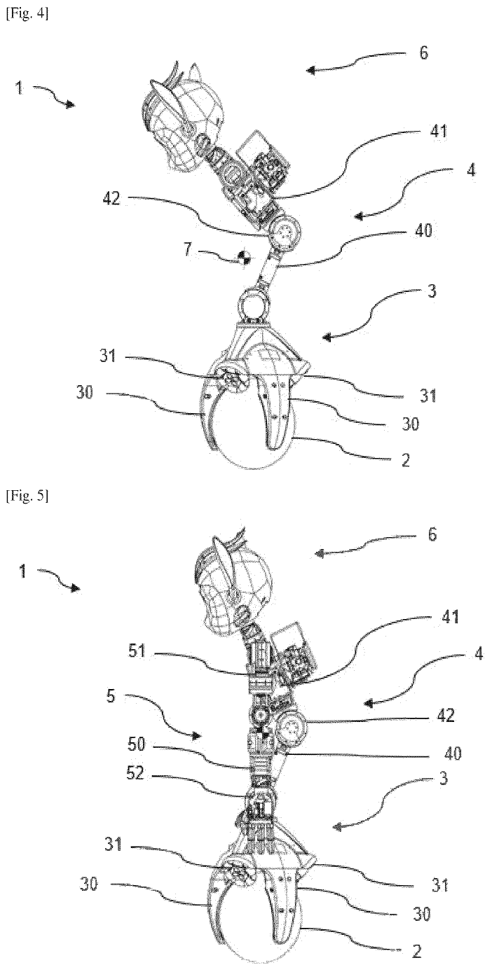

In addition, the robot according to the invention can be tilted between a straight position, shown in FIG. 1 to 3, and a tilted position, depicted in FIG. 4 to 9.

The trunk 4 has a first portion 40 and a second portion 41. Each of the first and second portions 40, 41 has a first end and a second end.

The first portion 40 is connected by its first end to the platform 3, by means of a pin joint or a ball-and-socket joint. The second portion 41 is connected by its first end to the upper part 6, by means of a pin joint or a ball-and-socket joint.

The second end of the first portion 40 is connected to the second end of the second portion 41 by means of a pin joint or a ball-and-socket joint.

According to one embodiment exemplified in the figures, the first portion 40 is connected by its first end to the platform 3 by means of a pin joint, the first portion 40 is connected by its second end to the second end of the second portion 41 by means of a pin joint, and the first end of the second portion 41 is connected to the upper part 6, by means of a pin joint.

According to another embodiment, not shown, the first portion 40 is connected by its first end to the platform 3 by means of a ball-and-socket joint, the first portion 40 is connected by its second end to the second end of the second portion 41 by means of a ball-and-socket joint, and the first end of the second portion 41 is connected to the upper part 6 by means of a ball-and-socket joint.

It is possible to combine the two embodiments hereinbefore, for example with the first portion 40 connected by its first end to the platform 3 by means of a ball-and-socket joint, the first portion 40 connected by its second end to the second end of the second portion 41 by means of a pin joint, and the first end of the second portion 41 connected to the upper part 6 by means of a ball-and-socket joint. In another example, the first portion 40 can be connected by its first end to the platform 3 by means of a pin joint, the first portion 40 can be connected by its second end to the second end of the second portion 41 by means of a ball-and-socket joint, and the first end of the second portion 41 is connected to the top part 6 by means of a pin joint.

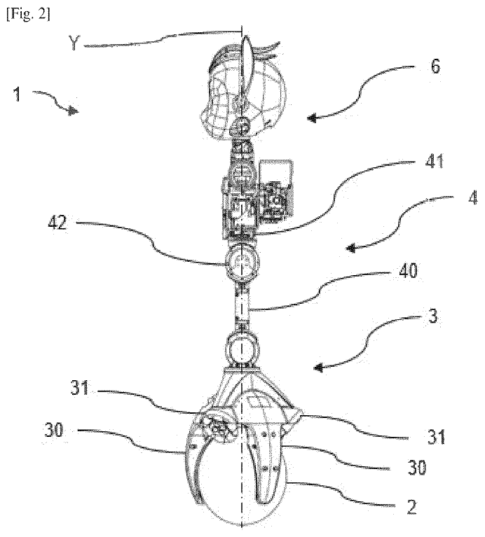

In the straight position, as depicted for example in FIGS. 1 and 2, the first portion 40 and the second portion 41 lie in the frontal plane A of the robot 1.

In the tilted position, as depicted for example in FIGS. 4 and 9, the first portion 40 and/or the second portion 41 are tilted with respect to the frontal plane A of the robot 1.

The trunk 4 is configured to maintain the position of the center of mass 7 of the robot 1, so as to allow the robot 1 to tilt towards the ground, while maintaining its balance.

The arm 5 has a distal segment 50 and a proximal segment 51 and a gripper, herein a hand 52. The proximal segment 51 is connected to the trunk 4 by means of a ball-and-socket joint or a pin joint, and also connected to the distal segment by means of a ball-and-socket joint or a pin joint. The distal segment 50 is also connected to the hand 52 by means of a pin joint or ball-and-socket joint.

Herein, the robot 1 has a plurality of arms 5. In such a case, each of the arms 5 has a distal segment 50 and a proximal segment 51, and a hand 52. The proximal segment 51 is connected to the trunk 4 by means of a ball-and-socket joint or a pin joint, and also connected to the distal segment by means of a ball-and-socket joint or a pin joint. The distal segment 50 is also connected to the hand 52 by means of a pin joint or ball-and-socket joint.

Each arm 5 is configured to be movable between a stretched position in which the distal and proximal segments are aligned and a bent position in which the proximal segment is tilted with respect to the distal segment.

The gripper has at least two fingers forming a clamp, the gripper being configured to grip objects.

In the example exemplified in the figures, the hand 52 is a robotic hand having a palm and a plurality of fingers.

In other embodiments, the hand can, for example, be a clamp or a suction cup.

The upper part 6 of the robot 1 has at least one sensor, especially a plurality of sensors and cameras, and is configured to enable the robot 1 to perceive its environment and, in particular, to detect the objects to be gripped and/or moved that are positioned opposite the upper part, within its field of vision.

In one particular example of the invention, the upper part 6 may have an RBG camera and/or an IR camera and/or a stereoscopic depth camera and/or a microphone and/or “Time Of Flight laser” sensors.

We will now describe various movements of the robot 1, referring to the figures.

In the straight, static position depicted in FIG. 1 to 3, the axis of the joint connecting the first end of the second portion 41 to the upper part 6, the axis of the joint connecting the second end of the second portion 41 to the second end of the first portion 40, and the axis of the joint connecting the first end of the first portion 40 to the platform 3 lie in the frontal plane A of the robot 1.

In this straight, static position, the robot, and in particular its trunk 4, extends substantially along a vertical axis Y, the vertical axis being orthogonal to the ground.

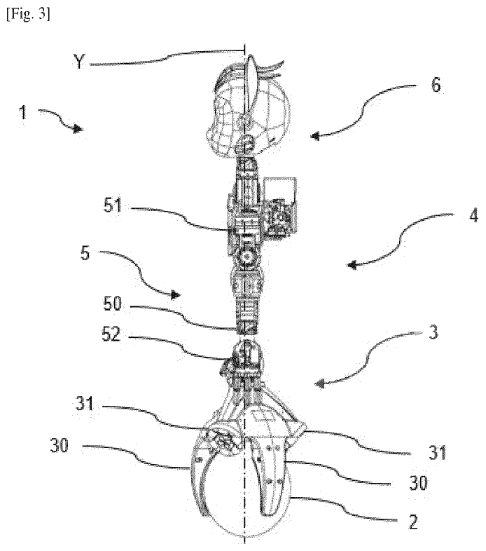

As can be seen in FIG. 3, the arms 5 extend in the vertical direction Y, along the trunk 4.

According to other examples, not shown, the arms can extend away from the trunk, i.e. the arms can be tilted with respect to the frontal plane A of the robot. When the robot has two arms, as is the case herein, both arms can be tilted with respect to the frontal plane A on the same side of said frontal plane A. Alternatively, both arms can be tilted with respect to the frontal plane A on either side of said frontal plane A.

In the straight, static position, the center of mass 7 lies in the frontal plane A. The robot 1 is stable on the spherical wheel 2.

When in motion, the robot 1 tilts in relation to the frontal plane A towards the desired direction. Thus, the center of mass 7 is shifted in this same direction, along the length of the trunk 4. The robot 1 is kept in balance by the movement of the spherical wheel 2.

In the tilted, static position, depicted in FIG. 4 to 9, at least the axis of the joint connecting the first end of the first portion 40 to the platform 3 lies in the frontal plane A of the robot 1. The axis of the joint connecting the second end of the second portion 41 to the second end of the first portion 40 is at a distance from the frontal plane A. The axis of the joint connecting the first end of the second portion 41 to the upper part 6 may lie in the frontal plane A or may be at a distance from the frontal plane A.

As shown in FIG. 4, the axis of the joint connecting the first end of the first portion 40 to the platform 3 lies in the frontal plane A of the robot 1, the axis of the joint connecting the second end of the second portion 41 to the second end of the first portion 40 is at a distance from the frontal plane A, towards the rear of the frontal plane A, and the axis of the joint connecting the first end of the second portion 41 to the upper part 6 lies in the frontal plane A.

The first portion 40 has pivoted about the axis of the pin joint connecting the first portion 40 to the platform 3. The first portion 40 is tilted with respect to the vertical direction Y. The second portion 41 has pivoted about the axis of the pin joint connecting it to the first portion 40, in the opposite direction to the first portion 40.

In the tilted, static position, the center of mass 7 lies in the frontal plane A. The robot 1 is stable on the spherical wheel 2.

As shown in FIG. 4, the upper part 6 is oriented towards the ground, allowing the robot's field of vision to take in the objects that are arranged thereon.

As shown in FIG. 5, the arms 5 of the robot 1 extend in the vertical direction Y. The center of mass 7 then lies in the frontal plane A.

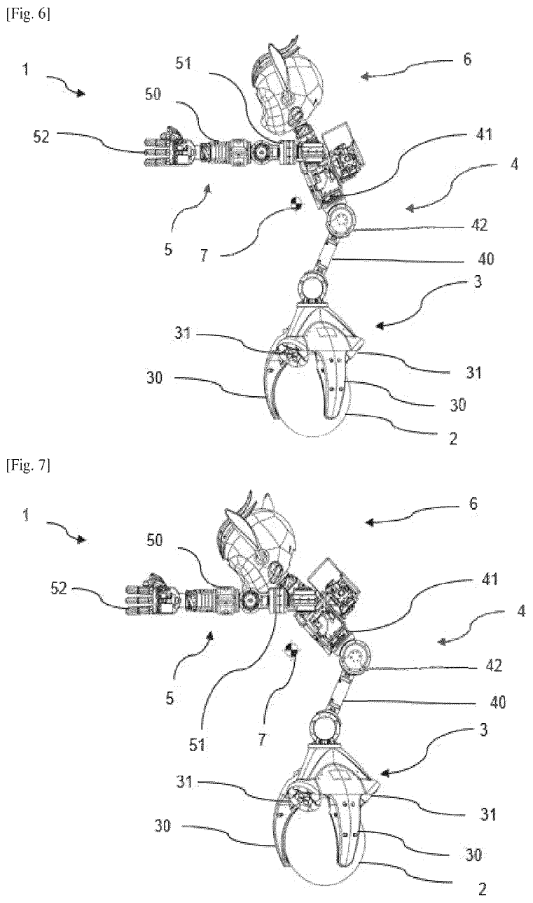

As shown in FIG. 6, the arms 5 of the robot 1 extend forwards from the frontal plane A, substantially parallel to the ground. In this position, the center of mass is shifted forwards from the frontal plane A. To maintain the balance of the robot 1 and return the center of mass 7 to the frontal plane A, the first portion 40 simply needs to pivot further back from the frontal plane A.

In FIG. 7, the robot 1 is tilted further than in FIG. 6. Indeed, the second portion 41 has pivoted further in the opposite direction to the pivoting direction of the first portion 40. The center of mass 7 is shifted forwards from the frontal plane A. To maintain the balance of the robot 1 and return the center of mass 7 to the frontal plane A, the first portion 40 simply needs to pivot further back from the frontal plane A.

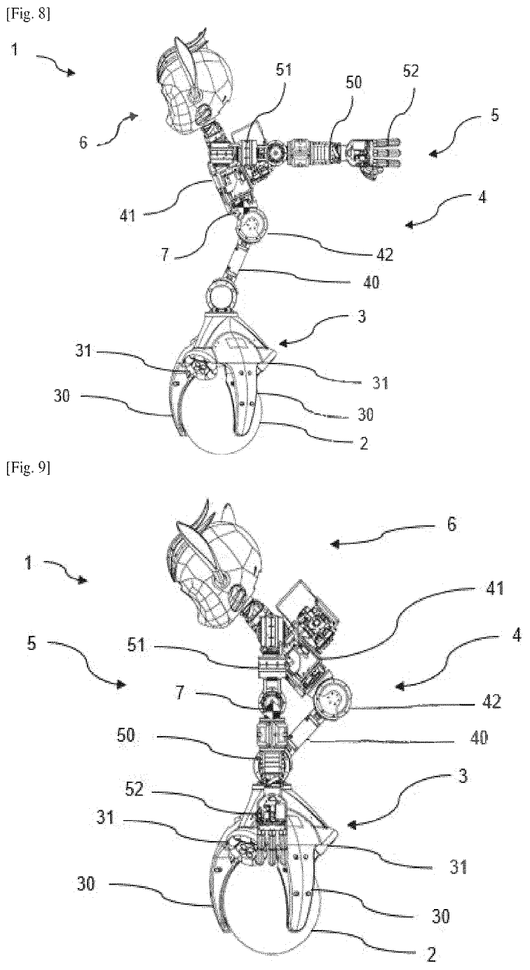

In FIG. 8, the arms of the robot 1 extend backwards from the frontal plane A, substantially parallel to the ground. In this position, the center of mass 7 is shifted backwards from the frontal plane A. To maintain the balance of the robot 1 and return the center of mass to the frontal plane A, the second portion 41 simply needs to pivot further in the opposite direction to the pivoting direction of the first portion 40.

In FIG. 9, which is a view similar to FIG. 5, except that the robot is tilted further, the center of mass lies in the frontal plane A, and the robot 1 is balanced on the spherical wheel 2. In this position, the first portion 40 is pivoted further backwards from the frontal plane A and the second portion 41 is pivoted further in the opposite direction to the pivoting direction of the first portion 40.

The robot 1 can be in a tilted position, as shown in FIG. 9 for example, with its arms extending on either side of the frontal plane A. In this case, the center of mass 7 lies in the frontal plane A and the robot 1 is balanced on the spherical wheel 2.

In particular, the axis of the joint connecting the first end of the first portion 40 to the platform 3 and the axis of the joint connecting the first end of the second portion 41 to the upper part 6 lie in the frontal plane A of the robot 1, and the axis of the joint connecting the second end of the second portion 41 to the second end of the first portion 40 is at a distance from the frontal plane A, towards the rear thereof.

Thus, the robot 1 is stable on the spherical wheel 2 in both static and moving positions, and in both straight and tilted positions. The robot 1 can therefore tilt towards the ground to pick up and/or move the objects in its environment. The robot 1 operates at variable heights, making it adaptable to its environment.

Also, the robot 1 can adapt to the load of the object to be moved and/or gripped. Indeed, the weight of the object can offset the center of mass, causing the robot to become unstable. To maintain the balance of the robot while carrying the object, the first and/or second portion simply needs to be pivoted so as to re-center the center of mass, in other words, to make it lie in the frontal plane A.

In one variant not shown in the figures, the gripping area of the robot can be increased, especially by increasing the length of the arms. If the arms are extended, the robot can access the ground, for example, or distances further away from its trunk.

The invention is not limited to the previously described embodiments, and instead extends to any equivalent embodiment.

1-10. (canceled)

11. A robot having a single spherical wheel for movement, configured to be in contact with the ground, and a platform mounted on the spherical wheel via stabilizing means, the robot being configured to be mobile on the ground by means of the spherical wheel suitable for rolling on the ground, the robot having a trunk, at least one arm and an upper part, said trunk being connected to the platform as well as to the upper part, the arm being connected by means of at least one pin joint or at least one ball-and-socket joint to said trunk, wherein said robot is tiltably movable between a straight position and a tilted position, said trunk of said robot having a first portion and a second portion, the first portion being connected by a first end to said platform at least by means of a pin joint or a ball-and-socket joint, the second portion being connected by a first end to the upper part and the first portion being connected by a second end to a second end of the second portion at least by means of a pin joint or a ball-and-socket joint, said trunk being configured to maintain the position of the center of mass of the robot so as to allow said robot to tilt towards the ground.

12. The robot according to claim 11, wherein the first portion is connected by a first end to said platform by means of a pin joint, and in that the first portion is connected by a second end to a second end of the second portion by means of a pin joint.

13. The robot according to claim 11, wherein the first portion is connected by a first end to said platform by means of a ball-and-socket joint, and in that the first portion is connected by a second end to a second end of the second portion by means of a ball-and-socket joint.

14. The robot according to claim 11, wherein, in the straight position, the axis of the joint connecting the first end of the second portion to the upper part, the axis of the joint connecting the second end of the second portion to the second end of the first portion, and the axis of the joint connecting the first end of the first portion to the platform lie in a frontal plane of said robot, and in that in the tilted position, at least the axis of the joint connecting the first end of the first portion to the platform lies in said frontal plane of said robot, the axis of the joint connecting the second end of the second portion to the second end of the first portion being at a distance from said frontal plane, and the axis of the joint connecting the first end of the second portion to the upper part lying in said frontal plane or at a distance from said frontal plane.

15. The robot according to claim 11, wherein it has two arms, said arms, in a tilted position, extending on either side of a frontal plane of the robot or on the same side of said frontal plane.

16. The robot according to claim 15, wherein, in a tilted position, the robot comprises two arms extending on the same side of the frontal plane and in that, in the tilted position, the axis of the joint connecting the first end of the first portion to the platform lies in said frontal plane of said robot, and the axis of the joint connecting the second end of the second portion to the second end of the first portion and the axis of the joint connecting the first end of the second portion to the upper part are at a distance from said frontal plane.

17. The robot according to claim 15, wherein, in a tilted position, the robot has two arms extending on either side of the frontal plane, and in that, in said tilted position, the axis of the joint connecting the first end of the first portion to the platform and the axis of the joint connecting the first end of the second portion to the upper part lie in said frontal plane of said robot, and the axis of the joint connecting the second end of the second portion to the second end of the first portion is at a distance from said frontal plane.

18. The robot according to claim 11, wherein the means for stabilizing the platform are configured to maintain the platform in a predetermined, especially horizontal, position with respect to the ground.

19. The robot according to claim 11, wherein said at least one arm has a distal segment and a proximal segment, the distal segment and the proximal segment being connected by a pin-type joint or a ball-and-socket-type joint, the arm being configured to be movable between a stretched position, in which the distal segment and the proximal segment are aligned, and a bent position, in which the proximal segment is tilted with respect to the distal segment.

20. The robot according to claim 11, wherein it additionally has at least one gripper, especially a hand, said gripper being connected by means of a pin joint or ball-and-socket joint to one end of said arm, said gripper having at least two fingers forming a clamp, said gripper being configured to grip objects.

21. The robot according to claim 11, wherein the upper part of the robot has at least one sensor configured to detect objects in a field of view facing the upper part.

22. The robot according to claim 11, wherein the upper part is connected to the first end of the second portion at least by means of a pin joint or a ball-and-socket joint.
